(19) United States
(12) Patent Application Publication
(10) Pub. No.: US 2014/0139429 A1
(43) Pub. Date: May 22, 2014

(54) SYSTEM AND METHOD FOR COMPUTER VISION BASED HAND GESTURE IDENTIFICATION

(71) Applicants: Ovadya Menadeva, Modiin (IL); Eran Eilat, Givatayim (IL); Amir Kaplan, Hod-HaSharon (IL)

(72) Inventors: Ovadya Menadeva, Modiin (IL); Eran Eilat, Givatayim (IL); Amir Kaplan, Hod-HaSharon (IL)

(21) Appl. No.: 14/131,712

(22) PCT Filed: Jul. 11, 2012
(86) PCT No.: PCT/IL12/50240

§ 371 Date: Jan. 9, 2014

Related U.S. Application Data
(60) Provisional application No. 61/506,218, filed on Jul. 11, 2011.

(51) Int. Cl. G06F 3/01

(52) U.S. Cl. CPC G06F 3/017
USPC 345/156

(57) ABSTRACT

The invention relates to a method for computer vision based hand gesture device control, which includes receiving 2D and 3D image information of a field of view which includes at least one user. An area of the user's hand is determined based on the 3D information and a shape of the user's hand is determined based on the 2D information. The detected shape of the hand and the position of the hand are then used to control a device.

### FIELD OF THE INVENTION

The present invention relates to the field of computer vision based control of electronic devices. Specifically, the invention relates to computer vision based hand identification using both 3D and 2D information.

### BACKGROUND OF THE INVENTION

Human hand gesturing is recently being used as an input tool for natural and intuitive man-machine interaction in which a hand gesture is detected by a camera and is translated into a specific command. Alternative computer interfaces (forgoing the traditional keyboard and mouse), video games and remote controlling are some of the fields that may implement control of devices by essentially touch-less human gesturing.

Gesture control usually requires identification of an object as a hand and tracking the identified hand to detect a posture or gesture that is being performed.

Color and edge information are sometimes used in the recognition of a human hand however some gesture recognition systems prefer the use of 3D imaging in order to avoid difficulties arising from ambient environment conditions (lighting, background, etc.) in which color and edge detection may be impaired. Systems using 3D imaging obtain position information for discrete regions on a body part of the person, the position information indicating a depth of each discrete region on the body part relative to a reference. A gesture may then be classified using the position information and the classification of the gesture may be used as input for interacting with an electronic device.

Some systems use skeleton tracking methods in which a silhouette from a multi-view image sequence is fitted to an articulated template model and non-rigid temporal deformation of the 3D surface may be recovered.

In some cases a depth map is segmented so as to find a contour of a humanoid body. The contour is processed in order to extract a skeleton and 3D locations (and orientations) of the user's hands.

Practically speaking, in the field of hand (or other body parts) recognition, 3D imagers are typically not capable of the high resolution of 2D imagers. For example, the D-Imager (Panasonic) for hand gesture recognition systems is capable of resolving 160×120 pixels at up to 30 frames per second. Such low resolution does not enable detection of details of a hand shape from a relatively high distance (hand gesture based operation of devices is typically done when a user is at a relatively high distance from the device) and may not enable to differentiate between different hand postures or may not at all enable identifying a hand posture. Thus, the 3D imager based systems do not provide a reliable solution for hand gesture recognition for control of a device.

### SUMMARY OF THE INVENTION

Embodiments of the present invention provide a system and method for hand gesture recognition which include the use of both 3D and 2D information. In one embodiment 3D information is used to identify a possible hand and 2D information is used to identify the hand posture.

According to another embodiment both 3D and 2D information are used to determine that an imaged object is a hand. 3D information is used to detect an object suspected as a hand and the 2D information is used to confirm that the object is a hand, typically by 2D shape recognition information. The 2D information may then be used to identify the hand posture.

In one aspect there is provided a system for computer vision based hand gesture identification. The system includes a 3D imager to image an object and a processor in communication with the 3D imager, to obtain 3D information from the 3D imager and to use the 3D information in determining if the object is a hand. The processor is to use 2D information to detect the shape of the object to identify a posture of the hand. Also included in the system is a controller to generate a control command to control a device based on the identified posture of the hand. The system may further include a display. The device of the system may be, for example, a TV, DVD player, gaming console, PC, mobile phone, Tablet PC, camera, STB (Set Top Box) or a streamer. Other devices suitable for being controlled may also be included in the system of the invention. The display may be a standalone display and/or may be integral to the device.

According to one embodiment the processor uses 3D information and 2D information in determining that an object is a hand.

According to one embodiment the system includes a processor to detect a change in a posture of the hand and the controller generates a command when a change in the posture of the hand is detected.

According to one embodiment a posture comprises a hand with finger tips bunched together as if something is held between the finger tips. Detection of this posture generates a control command to select content on the display and/or to manipulate the selected content.

In one aspect the system may include a 2D imager and the 2D information is derived from the 2D imager. In another embodiment the 2D information may be derived from 3D images. According to one embodiment the 2D information includes shape information. The system may include detectors, such as an object detector (which may be based on calculating Haar features), an edge detector and/or contour detector and other suitable detectors.

In one aspect the system includes a processor to apply skeleton tracking in determining if an object is a hand. The system may include a motion detector to detect movement of the object and if movement of the object is in a pre-determined pattern then it may be determined that the object is a hand.

In one embodiment the method includes receiving 2D and 3D image information of a field of view, said field of view comprising at least one user; determining an area of the user's hand (area typically including a location or position of the user's hand) based on the 3D information; detecting a shape of the user's hand, within the determined area of the user's hand, based on the 2D information; and controlling a device according to the detected shape of the hand.

For example, the method may include the steps of receiving a sequence of 2D images and a sequence of 3D images of a field of view, said images comprising at least one object; determining the object is a hand based information from the 3D images; applying a shape detection algorithm on the object from at least one image of the sequence of 2D images; determining a hand posture based on results of the shape detection algorithm; and controlling a device according to the determined hand posture.

According to one embodiment determining the object is a hand based on information from the 3D images is by applying skeleton tracking methods. According to another embodiment determining the object is a hand includes determining a shape of the object and if the shape of the object is a shape of a hand then determining the hand posture based on the results of the shape detection algorithm. In some embodiments applying a shape detection algorithm on the object from at least one image of the sequence of 2D images is done only after the step of determining the object is a hand based on information from the 3D images.

In some embodiments the shape detection algorithm comprises edge detection and/or contour detection. In some embodiments the shape detection algorithm comprises calculating Haar features.

In some aspects the method includes applying a shape detection algorithm on the object from more than one image of the sequence of 2D images. The method may include: assigning a shape affinity grade to the object in each of the more than one 2D images; combining shape affinity grades from at least two images (such as by calculating an average of the shape affinity grades from at least two images); and comparing the combined shape affinity grade to a predetermined posture's database or threshold to determine the posture of the hand.

In one aspect there is provided a method which includes applying a shape detection algorithm on the object from a first image and a second image of the sequence of 2D images; determining a hand posture in the first image and in the second image based on results of the shape detection algorithm; and if the posture in the first image is different than the posture in the second image then generating a command to control a device. The command to control the device may be a command to select content on a display.

In some embodiments the method includes checking a transformation between the first and second images of the sequence of 2D images and if the transformation is a non-rigid transformation then generating a first command to control the device and if the transformation is a rigid transformation then generating a second command to control the device. In one embodiment the first command is to initiate a search for a posture.

In some embodiments the method includes detecting movement of the object and determining the object is a hand based on information from the 3D images only if the detected movement is in a predefined pattern.

In some embodiments receiving a sequence of 3D images comprises receiving the sequence of 3D images from a 3D imager. In other embodiments the 3D images are constructed from 2D images.

In yet another aspect of the invention there is provided a method for computer vision based hand gesture device control which includes: receiving a sequence of 2D images and a sequence of 3D images of a field of view, said images comprising at least one object; determining the object is a hand based on information from the 2D images and 3D images; detecting a hand posture and/or movement of the hand; and controlling a device according to the detected hand posture and/or movement.

The method may also include applying a shape detection algorithm on the object from at least one image of the sequence of 2D images to detect the posture of the hand. Information from the 2D images may include, among others, color information, shape information and/or movement information. Information from the 3D images may be based on skeleton tracking methods.

In some embodiments determining the object is a hand based on information from the 2D images and 3D images includes determining a shape of the object in the 2D images. According to other embodiments determining the object is a hand based on information from the 2D images and 3D images includes detecting a predefined movement of the object in the 2D images.

In yet another aspect of the invention a method is provided which includes: determining two objects are two hands; applying shape detection algorithms on the two hands to determine a posture of at least one of the hands; if the determined posture of at least one of the hands corresponds to a pre-defined posture then generating a command to enable manipulation of the displayed content. The method may further include tracking movement of the two hands and manipulating the selected displayed content based on the tracked movement of the two hands. Manipulating the selected displayed content may include zooming, rotating, stretching, moving or a combination thereof.

### BRIEF DESCRIPTION OF THE DRAWINGS

The invention will now be described in relation to certain examples and embodiments with reference to the following illustrative figures so that it may be more fully understood. In the drawings

FIGS. 1A and 1B are schematic illustrations of a system for computer vision based hand gesture identification according to embodiments of the invention;

FIG. 2 is a schematic illustration of a method for computer vision based hand gesture control according to an embodiment of the invention;

FIG. 3 is a schematic illustration of a method for computer vision based hand gesture control using shape information from more than one image, according to an embodiment of the invention;

FIGS. 4A and 4B are schematic illustrations of a method for computer vision based hand gesture control based on change of shape of the hand, according to embodiments of the invention; and

FIG. 5 is a schematic illustration of a method for computer vision based gesture control using more than one hand, according to an embodiment of the invention.

### DETAILED DESCRIPTION OF THE INVENTION

According to an embodiment of the invention a system for user-device interaction is provided which includes a device and a 3D image sensor which is in communication with a processor. The 3D image sensor obtains image data and sends it to the processor to perform image analysis to determine if an imaged object is a user's hand. The processor (the same processor or another processor) uses 2D information, typically shape information which is obtained from the image data (image data obtained by the 3D imager or by a different 2D imager) to determine a shape or posture of the hand. A processor then generates user commands to the device based on the determined posture, thereby controlling the device based on computer vision using 3D and 2D information.

According to another embodiment the 3D image sensor obtains image data and sends it to the processor to perform image analysis to make a first determination that an imaged object is a hand, e.g., by detecting an area which may include the user's hand. The processor then uses 2D information (typically shape information) to make a second determination that the imaged object is a hand. According to some embodiments a final determination that an imaged object is a hand is made only if both first and second determinations are made that the imaged object is a hand. 2D information may then be further used to determine a posture (e.g., a specific shape) of the hand to control a device.

According to embodiments of the invention the user commands are based on identification of a hand posture and tracking of a user's hand. A user's hand is identified based on 3D information (or 3D information in combination with 2D information), which is less sensitive to ambient environment conditions however, the specific posture of the hand is typically detected based on 2D information which can be obtained at a higher resolution than 3D information.

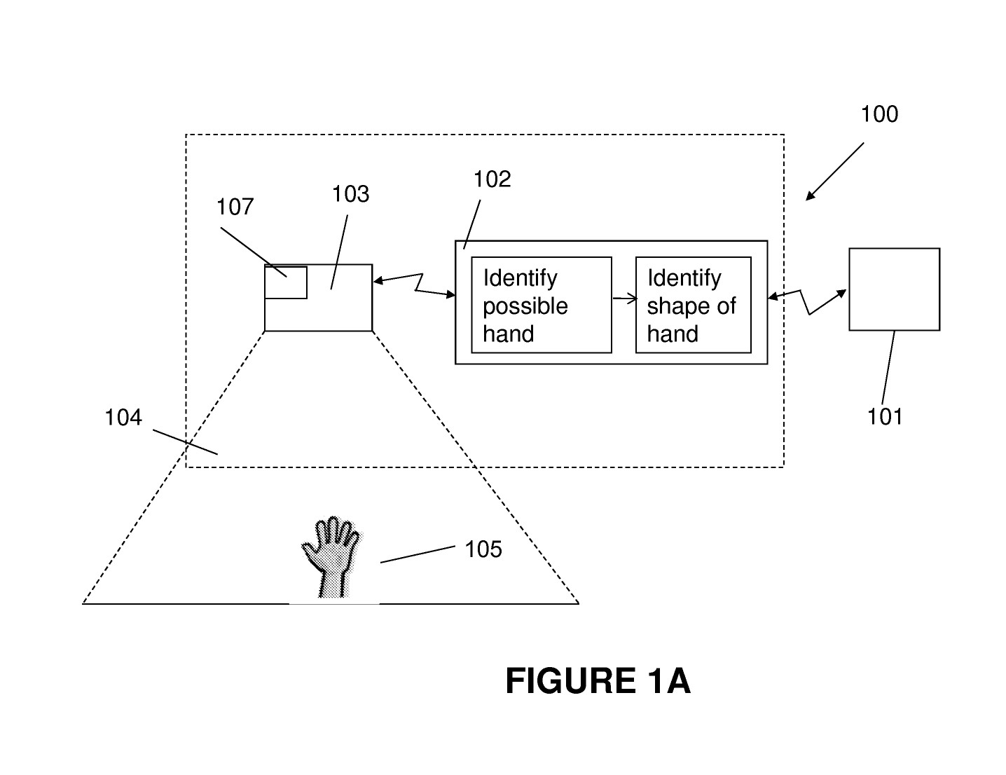

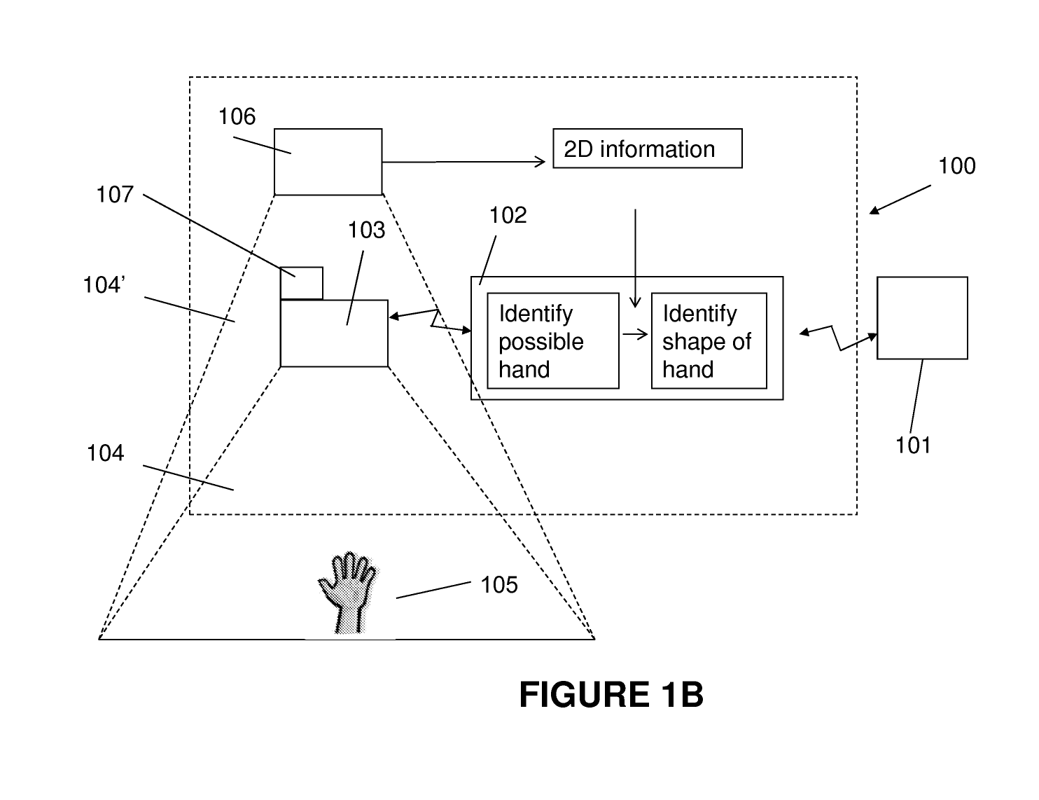

Reference is now made to FIG. 1A which schematically illustrates a system 100 according to an embodiment of the invention. System 100 includes a 3D image sensor 103 for obtaining a sequence of images of a field of view (FOV) 104 which includes an object (such as a user and/or user's hand 105).

The 3D image sensor 103 may be a known camera such as a time of flight camera or a device such as the Kinect™ motion sensing input device. 3D information may be gathered by image deciphering software that looks for a shape that appears to be a human body (a head, torso, two legs and two arms) and calculates movement of the arms and legs, where they can move and where they will be in a few microseconds. In some systems depth maps are used in the detection of a suspected hand. A sequence of depth maps is captured over time of a part of a body of a human subject. The depth maps are processed in order to detect a direction and speed of movement of the part of the body and to determine that the body part is a hand based on the detected direction and speed. For example, if a body part is moved away from the body, the system may identify that body part as a gesturing hand. In another example, an object moving towards the camera and then back away from the camera may be detected as a suspected hand. In yet another example, an object that is closer than expected (based on the expected location for the suspected limb or body part) and is moving in a waving motion may be detected as a suspected hand.

Image sensor 103 is typically associated with processor 102, and storage device 107 for storing image data. Storage device 107 may be integrated within image sensor 103 or may be external to image sensor 103. According to some embodiments image data may be stored in processor 102, for example in a cache memory.

Image data of the field of view (FOV) 104 is sent to processor 102 for analysis. 3D information is constructed by processor 102, based on the image data received from the 3D imager 103. Images of the FOV 104 are also analyzed for 2D information (for example, shape information). Based on the 3D information and the 2D information a determination is made whether the imaged object is a user's hand, e.g., the 3D information is used in determining an area of the user's hand and the 2D information is used to detect a shape of the user's hand. Based on the identified shape, a user command is generated and is used to control device 101.

According to some embodiments the image processing is performed by a first processor which then sends a signal to a second processor in which a user command is generated based on the signal from the first processor.

According to some embodiments the system 100 may include a motion detector to detect movement of the object and if movement of the object is determined (e.g., by a processor) to be in a pre-determined pattern (such as a hand moving left and right in a hand waving motion) then a first determination that the object is a hand may be made. A final determination or confirmation that the object is a hand may be made based on the first determination alone or based on the first determination and additional information (such as shape information of the object).

Device 101 may be any electronic device that can accept or that can be controlled by user commands, e.g., gaming console, TV, DVD player, PC, Tablet PC, mobile phone, camera, STB (Set Top Box), streamer, etc. According to one embodiment, device 101 is an electronic device available with an integrated standard 2D camera.

Processor 102 may be integral to image sensor 103 or may be a separate unit.

Alternatively, the processor 102 may be integrated within the device 101. According to other embodiments a first processor may be integrated within image sensor 103 and a second processor may be integrated within device 101.

The communication between image sensor 103 and processor 102 and/or between processor 102 and device 101 and between other components of the system may be through a wired or wireless link, such as through IR communication, radio transmission, Bluetooth technology and other suitable communication routes.

According to another embodiment which is schematically illustrated in FIG. 1B, the system further includes a 2D image sensor 106 from which 2D information of the FOV 104′ is obtained. Processor 102 may include a detector, such as an edge detector and/or a contour detector.

According to one embodiment a possible user's hand 105 is identified by using 3D information (which may be obtained from the 3D imager 103 and/or from images obtained by the 2D image sensor 106, such as by utilizing stereo vision or structure from motion (SFM) techniques) and only after the identification of a possible hand (e.g., by identifying an area of the hand or a position of the hand) based on 3D information, the hand is confirmed by 2D information and 2D information of FOV 104′ may be used to identify a posture of the hand.

The 2D image sensor 106 may be a standard webcam typically installed on PCs or other electronic devices, or another 2D RGB (or B/W and/or IR sensitive) video capture device.

According to one embodiment the 3D imager 103 and the 2D image sensor 106 are both integrated into the same device (e.g., device 101 or in an accessory device) positioned such that both may be directed at the same FOV. Calculating the angle at which the 2D imager should be directed may be done by imagining a right angle triangle in which one side is the known distance between the 3D and 2D sensors and the other side is the known distance from the 3D imager to an object (based on the known depth of the 3D pictures obtained from the 3D imager). The line of view of the 2D imager to the object (which is the hypotenuse of the triangle) can thus be calculated.

2D information may include any information obtainable from a single image or from a set of images but which relates to visual objects that are constructed on a single plane having two axes (e.g., X and Y; width and height). Examples of 2D information may include shape information, such as edge information and/or contour information. Other physical properties of an object may also be included in 2D information, such as texture and color.

According to some embodiments the system may include an object detector, the object detector based on calculating Haar features. The system may further include additional detectors such as an edge detector and/or contour detector.

One example of a method for obtaining edge information is the use of the Canny™ algorithm available in computer vision libraries such as Intel™ OpenCV. Texture detectors may use known algorithms such as texture detection algorithms provided by Matlab™.

Shape detection methods may use an algorithm for calculating Haar features. Contour detection may be based on edge detection, typically, of edges that meet some criteria, such as minimal length or certain direction.

A posture, according to one embodiment, relates to the pose of the hand and the shape it assumes at that pose. In one example a posture resembles a “grab” pose of the hand (hand having the tips of all fingers brought together such that the tips touch or almost touch each other).

System 100 may be operable according to methods, some embodiments of which are described below.

According to one embodiment a sequence of images of a field of view is received and 3D information is constructed from the sequence of images. The field of view typically includes an object. Based on the 3D information a determination is made whether the object is a hand. According to some embodiments a first determination may be made based on 3D information, in which an object is detected as a “suspected hand”. A second determination further confirms that the object is a hand based on 2D shape information of the object in which it is determined that the object has a shape of a hand.

If it is determined, based on the 3D information (possibly in combination with 2D information), that the object is not a hand then another image or set of images is received for analysis. If it is determined, based on the 3D information (possibly in combination with 2D information), that the object is a hand then shape detection algorithms are applied on the object. According to one embodiment a determination of a hand based on 3D information is made only after which shape detection algorithms are applied. According to another embodiment 3D information and shape information may be analyzed concurrently.

According to some embodiments movement of the object may be detected and if the movement of the object is determined to be in a pre-determined pattern (such as a waving motion) then, based on 3D information (and possibly 2D information) and based on the determined movement, the object is identified as a hand.

The shape detection algorithms may be applied on one image or on a set of images. A posture of the hand is determined based on the results of the shape detection algorithm and a device (such as device 101) may be controlled based on the determined posture.

The step of determining whether the object is a hand based on 3D information may be done as known in the art, for example by skeleton tracking methods or other analysis of depth maps, for example, as described above. The step of applying shape detection algorithms may include the use of a feature detector or a combination of detectors may be used.

As described above, known edge detection methods may be used. In another example, an object detector may be applied together with a contour detector. In some exemplary embodiments, an object detector may use an algorithm for calculating Haar features. Contour detection may be based on edge detection, typically, of edges that meet some criteria, such as minimal length or certain direction. Contour features of a hand may be compared to a contour model of a hand in a specific posture in order to determine the posture of the hand. According to other embodiments an image of a hand analyzed by using shape information may be compared to a database of postures in order to determine the posture of the hand. According to some embodiments machine learning algorithms may be applied in determining the posture of a hand based on shape information.

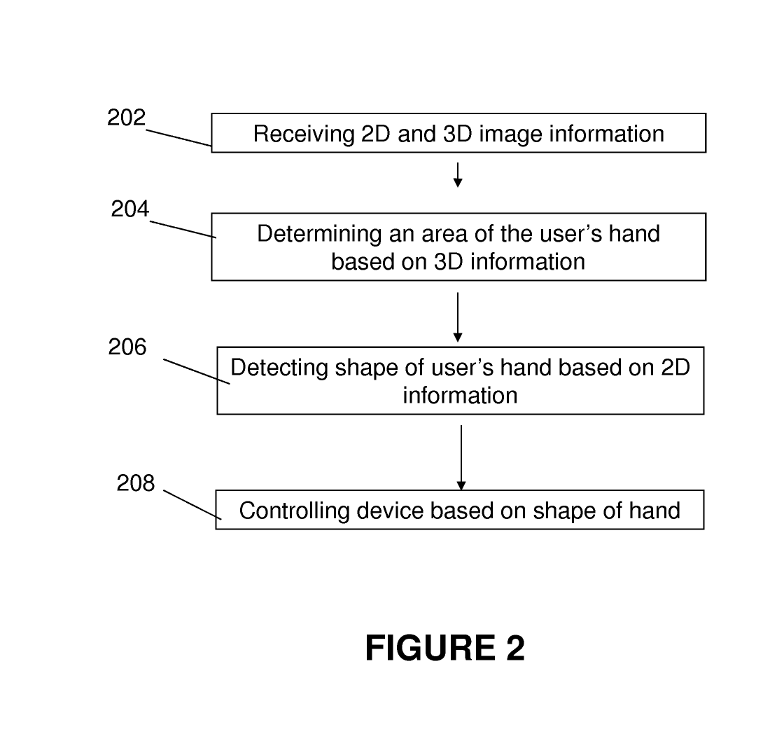

Reference is now made to FIG. 2 which schematically illustrates a method for computer vision based hand gesture control according to an embodiment of the invention.

According to one embodiment the method includes receiving 2D and 3D image information of a field of view which includes at least one user (202); determining an area of the user's hand (e.g., an area or position of a suspected hand) based on the 3D information (204); detecting a shape of the user's hand, within the determined area, based on the 2D information (206); and controlling a device according to the detected shape of the hand (208).

Determining the area of the user's hand may be done by applying skeleton tracking methods on the 3D information. Determining the shape of the user's hand typically involves applying a shape detection algorithm (such as edge detection and/or contour detection algorithms) on the 2D information.

According to some embodiments shape information from more than one image may be used in determining the posture of a hand.

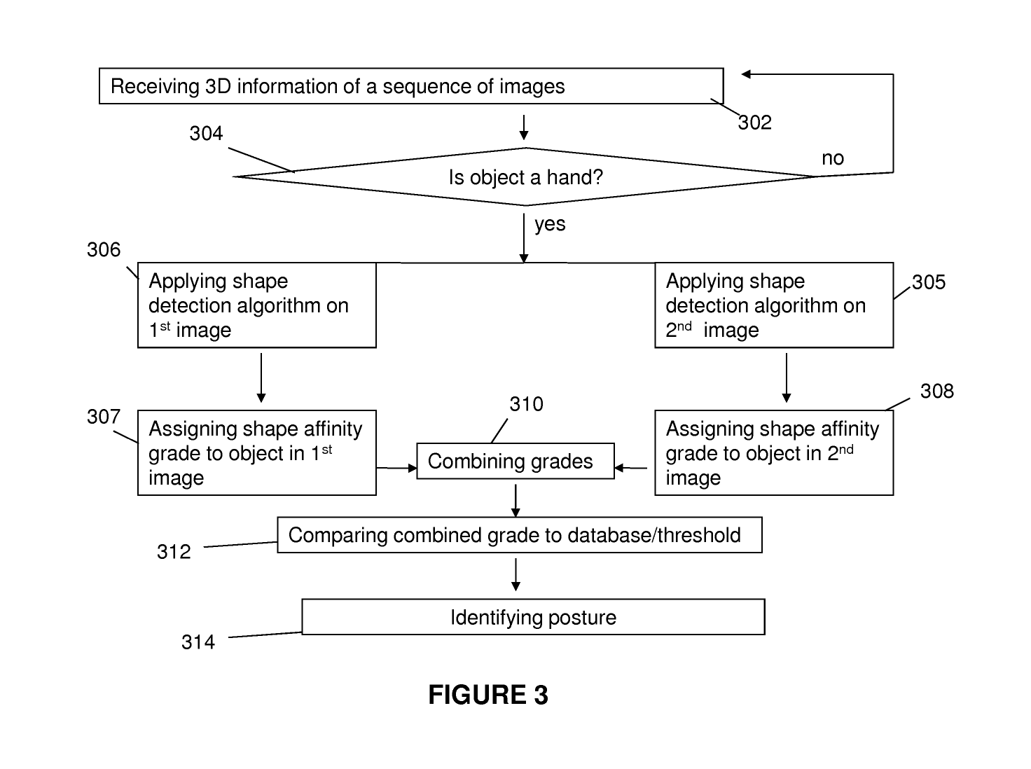

An exemplary method for computer vision based hand gesture control using shape information from more than one image is schematically illustrated in FIG. 3.

3D information of a sequence of images is received (302) and a determination is made, based on the received 3D information, whether there is a suspected hand in the sequence of images (304). If no suspected hand is detected in the sequence of images, another sequence of images is analyzed. If a suspected hand is detected, based on the 3D information, shape detection algorithms are applied on a first image (305) and on a second image (306). Shape information obtained from the shape detection algorithms applied on the first image and information obtained from the shape detection algorithms applied on the second image are combined (310) and the combined information is compared to a database of postures (312) to identify the posture of the hand (314).

According to one embodiment a shape affinity grade is assigned to the hand in the first image (307) and a shape affinity grade is assigned to the hand in the second image (308). The shape affinity grades are combined (310), for example by calculating an average of the affinity grades from at least two images, and the combined grade is compared to a “posture threshold” to determine if the hand is posing in a specific posture.

According to some embodiments a combined image may be created and a shape recognition algorithm may be applied to the combined image. For example, two images can be subtracted and detection of a contour can be applied on the subtraction image. The detected contour may then be compared to a model of a hand contour posture shape in order to confirm the posture of the hand. In another example more than one shape recognition algorithm is applied, e.g., both edge detection and contour detection algorithms are applied substantially simultaneously on the subtraction image.

The methods according to embodiments of the invention may be used, for example, in remote control of a TV or other type of device with a display. According to one embodiment a user may use postures such as an open hand, fingers extended posture to initiate a program, for example, to initiate the display of a slide show on a monitor screen or other display. When the user brings his fingers together, e.g., so that the tips of his fingers are bunched together as if the user is holding something between the tips of his fingers, that posture may be translated to a “grab” or select command such that specific content being displayed may be selected and manipulated by the user when using the “grab” posture. Thus, a method according to embodiments of the invention may include confirming a posture of the user's hand based on the shape of the user's hand and enabling control of the device based on a predetermined posture.

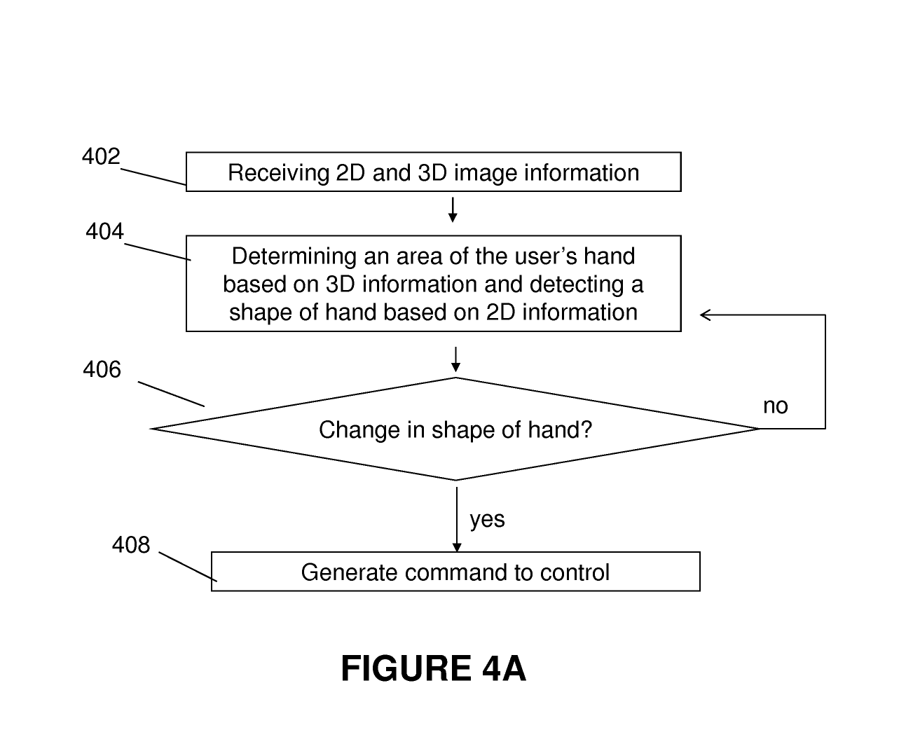

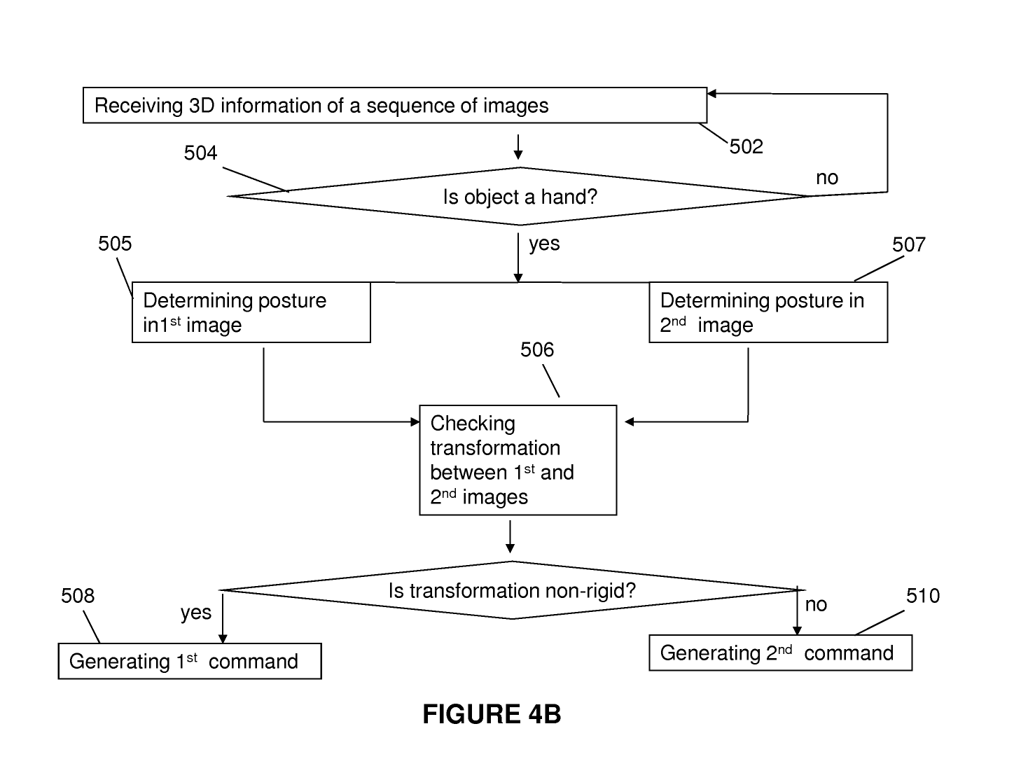

According to one embodiment, which is schematically illustrated in FIG. 4A, the method includes receiving 2D and 3D image information of a sequence of images of a field of view which includes at least one user (402); determining an area of the user's hand based on the 3D information and detecting a shape of the user's hand based on the 2D information (404); detecting a change in the shape of the user's hand, typically in between images of the sequence of images (406); and generating a command to control the device based on the detected change of shape (408).

According to one embodiment a change in the shape of the use's hand includes first detecting one posture of the user's hand and then detecting another, different posture of the user's hand.

Typically, the command generated based on a predetermined posture or based on the detection of a change of shape of the hand, is a command to select content on a display. A “select command” may emulate a mouse click. For example content on a display may be selected based on detection of a grab posture or on the detection of a change in posture of the hand (e.g., detecting a hand with all fingers extended in one image and a hand in “grab” posture in a next image). Applications may be opened or content marked or any other control of the device may be enabled by the select command.

According to one embodiment, which is schematically illustrated in FIG. 4B, a method for computer vision based hand gesture control is used to generate different types of control commands. The method includes receiving 3D information of a sequence of images (502) and determining, based on the received 3D information (possibly in combination with 2D information or other information such as detection of a pre-defined movement), whether there is a hand in the sequence of images (504). If no hand is detected in the sequence of images, another sequence of images is analyzed. If a hand is detected, based on the 3D information, then, optionally, a hand posture in a first image and in a second image are determined (505 and 507), typically by applying shape detection algorithms on the first and second images.

According to one embodiment a specific command may be initiated by detecting a change of posture of the user's hand. For example, if the posture of the hand (e.g., as determined by the shape detection algorithms) in the first image is different than the posture of the hand in the second image then a specific command may be generated.

According to one embodiment a change of posture of the hand will typically result in relative movement of pixels in the image in a non-rigid transformation whereas movement of the whole hand (while maintaining the same posture) will typically result in a rigid transformation. Thus, according to one embodiment, if the transformation between two images is a non-rigid transformation this indicates change of posture of the hand. According to one embodiment the first and second images are checked for the transformation between them (506). If the transformation is found to be a non-rigid transformation then a first command to control a device is generated (508) and if the transformation is found to be a rigid transformation then a second control command is generated (510).

Checking the transformation between the first and second image of the user's hand is beneficial, for example, in reducing computation time. For example, according to one embodiment, detecting a hand posture includes comparing the shape of a hand to a library or database of hand posture models. It is possible, according to embodiments of the invention, to initiate this comparison only when it is likely that a user is changing a hand posture, instead of applying the comparison continuously. Thus, according to one embodiment a specific command that is generated in response to detecting a change of posture is a command to initiate a process of searching for a posture (e.g., by comparing to a library of models).

According to one embodiment of the invention, the first command that is generated when a different posture is detected or the first command generated if the transformation is found to be a non-rigid transformation, may be to select content on a display (such as a graphical element (e.g., cursor or icon) or an image) and the second command may be to manipulate the selected content according to movement of the user's hand (such as to move, rotate, zoom and stretch the selected content). In another embodiment the first command is to initiate a process of searching for a posture (e.g., by comparing to a library of models).

Embodiments of the invention include tracking the user's hand to determine the position of the user's hand in time and controlling the device according to the determined position. Tracking of an object that was determined to be the user's hand may be done by known methods, such as by selecting clusters of pixels having similar movement and location characteristics in two, typically consecutive images. The tracking may be based on the 2D image information or on the 3D information or on both 2D and 3D information. For example, X and Y coordinates of the position of the user's hand may be derived from the 2D information and coordinates on the Z axis may be derived from the 3D information.

During tracking, in order to avoid losing the user's hand, an area or position of the user's hand may be determined based on 3D information, every frame or every few frames or every set period of time to verify that the object being tracked is indeed the user's hand. Verification of the tracking may also be done by detecting the shape of the user's hand based on the 2D information, every frame or every few frames or every set period of time.

In some cases the system may identify more than one object to be tracked (e.g., clusters of pixels are selected in two different locations). If there are several tracking options, the correct tracking option may be decided upon based on the 3D information, e.g., based on position of the user's hand (or clusters of pixels) on the Z axis, such that clusters of pixels located too far away or too close to represent a user's hand, may be discredited and will not be further tracked.

In some cases, for example, when there are several hands in the FOV, a plurality of areas of the user's hand are determined based on the 3D information. In this case a shape of the user's hand may be detected in each of the plurality of determined areas; and if a predetermined shape of a hand is detected in at least one of the areas of the user's hands, then the device may be controlled according to the predetermined shape of the hand.

According to some embodiments a gesture may include two hands. For example content on a display may be selected based on detection of a grab posture of one or two hands but manipulation of the selected content (e.g., zoom, stretch, rotate, move) may be done based only upon detection of two hands. Thus, for example, content may be manipulated on a display based on the relative distance of the two hands from each other.

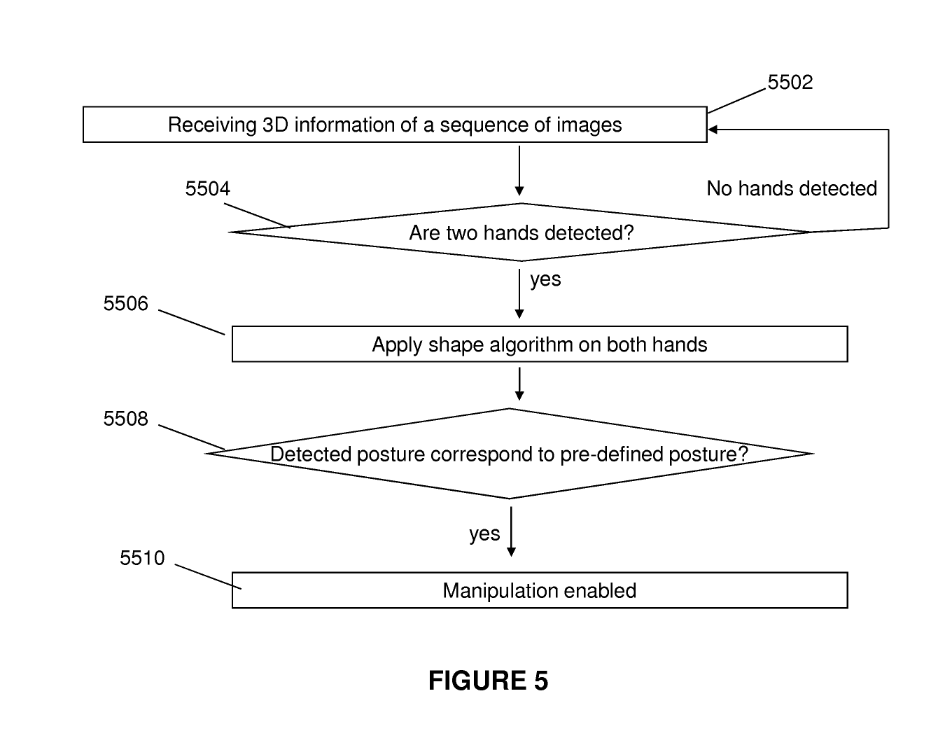

A method for computer vision based hand gesture control used to manipulate displayed content using more than one hand, according to one embodiment of the invention, is schematically illustrated in FIG. 5.

According to one embodiment the method includes receiving 3D information of a sequence of images (5502) and determining, based on the received 3D information (possibly in combination with 2D information or information obtained from 2D images such as detection of a pre-defined movement), whether there are two hands in the sequence of images (5504). If no hand is detected in the sequence of images, another sequence of images is analyzed. If only one hand is detected then the system may proceed to control a device as described above. If, based on the 3D information (possibly in combination with 2D information), two hands are detected then shape detection algorithms are applied on both hands (5506) to determine the posture of at least one of the hands, for example, as described above. If the detected posture corresponds to a specific pre-defined posture (5508) a command (e.g., a command to select displayed content) is generated and the manipulation of the displayed content is enabled (5510).

According to one embodiment, the presence of a second hand in the field of view enables a “manipulation mode”. Thus, a pre-defined hand posture (e.g., a select or “grab” posture) together with the detection of two hands enables manipulation of specifically selected displayed content. For example, when a grab posture is performed in the presence of a single hand content or a graphical element may be “clicked on” (left or right click) or dragged following the user's single hand movement but in response to the appearance of a second hand, performing the grab posture may enable manipulation such as rotating, zooming or otherwise manipulating the content based on the user's two hands' movements.

According to some embodiments an icon or symbol correlating to the position of the user's hand(s) may be displayed such that the user can, by moving his/her hand(s), navigate the symbol to a desired location of content on a display to select and manipulate the content at that location.

According to one embodiment displayed content may be manipulated based on the position of the two detected hands. According to some embodiments the content is manipulated based on the relative position of one hand compared to the other hand. Manipulation of content may include, for example, moving selected content, zooming, rotating, stretching or a combination of such manipulations. For example, when performing a grab posture, in the presence of two hands, the user may move both hands apart to stretch a selected image. The stretching would typically be proportionate to the distance of the hands from each other.

Typically, the method includes tracking movement of each of the two hands and manipulating the selected displayed content based on the tracked movement of the two hands. Tracking movement of one or two hands may be done by known tracking techniques.

Content may be continuously manipulated as long as a first posture is detected. To release the manipulation of the content a second posture of at least one of the two hands needs to be detected and based on the detection of the second posture the manipulation command may be disabled and the displayed content may be released of manipulation. Thus, for example, once the user has stretched an image to its desired proportions the user may change the posture of one or two of his/her hands to a second, pre-defined “release from grab posture” and the image will not be manipulated further even if the user moves his/her hands.

According to some embodiments a posture may be identified as a “grab posture” only if the system is in “manipulation mode”. A specific gesture, posture or other signal may need to be identified to initiate the manipulation mode. For example, a posture may be identified as a “grab posture” and content may be manipulated based on this posture only if two hands are detected.

In one embodiment, initiation of “manipulation mode” is by detection of an initialization gesture, such as, a pre-defined motion of one hand in relation to the other, for example, moving one hand closer or further from the other hand. According to some embodiments an initializing gesture includes two hands having fingers spread out, palms facing forward. In another embodiment, specific applications may be a signal for the enablement of “manipulation mode”. For example, bringing up map based service applications (or another application in which manipulation of displayed content can be significantly used) may enable specific postures to manipulate displayed maps.

In some embodiments an angle of the user's hand relative to a predetermine plane (e.g., relative to the user's arm or relative to the user's torso) may be determined, typically based on 3D information. The angle of the user's hand relative to the plane is then used in controlling the device. For example, the angle of the user's hand may be used to differentiate between postures or gestures of the hand and/or may be used in moving content on a display.

1-37. (canceled)

38. A method for computer vision based hand gesture device control, the method comprising:
receiving 2D and 3D image information of a field of view, said field of view comprising at least one user;
using a processor;
determining an area of a hand of the user based on the 3D information;
detecting a shape of the user's hand, within the determined area of the user's hand, based on the 2D information; and
controlling a device according to the detected shape of the hand.

39. The method of claim 38 comprising applying a shape detection algorithm to determine the shape of the user's hand.

40. The method of claim 38 comprising;
detecting a change in the shape of the user's hand; and
generating a command to control the device based on the detected change.

41. The method of claim 40 wherein detecting a change in the shape of the user's hand comprises detecting a first posture of the user's hand and a second posture of the user's hand.

42. The method of claim 40 wherein detecting a change in the shape of the user's hand comprises checking a transformation between a first and second image and if the transformation is a non-rigid transformation then generating a first command to control the device and if the transformation is a rigid transformation then generating a second command to control the device.

43. The method of claim 42 wherein the first command is to initiate a search for a predetermined posture.

44. The method of claim 38 comprising tracking the user's hand to determine the position of the user's hand and controlling the device according to the determined position.

45. The method of claim 44 wherein, if there are several tracking options, comprising deciding on a correct tracking option based on the 3D information or based on the 2D information.

46. The method of claim 45 wherein the 2D information comprises shape information.

47. The method of claim 38 wherein a plurality of areas of the user's hand are determined based on the 3D information.

48. The method of claim 47 comprising:
detecting a shape of the user's hand in each of the plurality of determined areas; and
if a predetermined shape of a hand is detected in at least one of the areas of the user's hands, then controlling the device according to the predetermined shape of the hand.

49. The method of claim 48 comprising tracking the user's hand in each of the plurality of areas of user's hands.

50. A method for computer vision based hand gesture device control, the method comprising:
based on a sequence of 2D images and a sequence of 3D images of a field of view, said images comprising at least one object, using a processor to:
determine the object is a hand based on information from the 2D images and 3D images;
detect a hand posture or movement of the hand; and
control a device according to the detected hand posture or movement.

51. The method of claim 50 wherein information from the 3D images comprises information related to movement.

52. The method of claim 51 wherein the information related to movement comprises movement in a pre-determined pattern.

53. The method of claim 50 wherein information from the 2D images comprises shape information.

54. A system for computer vision based control of a device, the system comprising:
a processor to obtain 3D and 2D information from images of a user and to use the 3D and 2D information to detect a shape of a hand of the user in the images; and
generate a control command based on the detected shape of the hand, the control command to control a device.

55. The system of claim 54 wherein the processor is to use the 3D information in determining an area of the user's hand and use the 2D information to detect the shape of the user's hand in the area of the user's hand.

56. The system of claim 54 wherein the device comprises a display and wherein the control command is a command to select or manipulate content on the display.

57. The system of claim 54 comprising at least one imager to obtain the images of the user, said imager in communication with the processor.
